(19) United States
(12) Patent Application Publication
(10) Pub. No.: US 2009/0058863 A1
(43) Pub. Date: Mar. 5, 2009

(54) Image animation with transitional images

(75) Inventors: Gokhan Avkarogullari, San Jose, CA (US); Szu-Wen Huang, Fremont, CA (US)

Correspondence Address: APPLE INC.;c/o Fletcher Yoder, PC, P.O. Box 692289, Houston, TX, 77269-2289, US

(73) Assignee: Apple Inc.

(21) Appl. No.: 11/899,144

(22) Filed: Sep. 4, 2007

(51) Int. Cl. G06T 13/00

(52) U.S. Cl. 345/473

(57) ABSTRACT

A technique is provided for animating an image or a portion of an image. In accordance with this technique, intermediary or transitional images, referred to as offset images, are displayed as part of an animation step to lessen abrupt changes in pixel values. In one embodiment, the offset images are generated using a weighted average of proximate pixels. In such an embodiment, the weight factor may take into account the distance of the offset from the proximate pixels such that closer pixels are more heavily weighted. Based on the direction of movement for the animation, the offset images are ordered and displayed as part of the animation steps of an animation sequence.

### BACKGROUND OF THE INVENTION

1. Field of the Invention

The present invention relates generally to image processing, and more particularly to the animation of images.

2. Description of the Related Art

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Portable electronic devices increasingly include display screens as part of the user interface of the device. Such display screens may be useful for displaying status information about the device or for displaying information about an operation being performed by the device. For example, portable music and/or video players may display information about a music or video file being played by the device, such as the title of the song or show being played, the time remaining, the time elapsed, or the artist, cast or other information of interest. Alternatively, the display of such a device may display a piece of artwork or an arbitrary design during operation of the device.

In some instances it may be desirable, for aesthetics or other reasons, to animate one or more of the images being displayed on a portable electronic device. For example, a logo may be animated to move on the display or to move on and off of the screen. Likewise, artwork, such as cover art, avatars, emoticons, or other images, may be displayed and animated on the device during operation.

Animation of images, however, may appear blocky or crudely rendered, particularly on the small displays often on found portable electronic devices. In particular, the displays typically present on portable electronic devices may have a limited number of pixels per square inch. As a result, the transition between a pixel displaying at little or no intensity to the pixel displaying at a high intensity, such as when an animated object transitions across the display, may be noticeable to the human eye. Such a noticeable transition may be perceived by the viewer as abrupt and may not be aesthetically pleasing. In other words, a small display, such as may be present on a portable electronic device, may have too few pixels to allow smooth, seamless animation of images on the display.

### SUMMARY

Certain aspects of embodiments disclosed herein by way of example are summarized below. It should be understood that these aspects are presented merely to provide the reader with a brief summary of certain forms an invention disclosed and/or claimed herein might take and that these aspects are not intended to limit the scope of any invention disclosed and/or claimed herein. Indeed, any invention disclosed and/or claimed herein may encompass a variety of aspects that may not be set forth below.

There is provided a technique for animating all or part of an image. In accordance with aspects of this technique, one or more offset images are generated for each step in the animation sequence. Each pixel of an offset image will have a value that is between the pixel's value prior to the animation step and the pixel's value subsequent to the animation step (if the pixel's value changes during the animation step). Thus the offset images provide an incremental transition between the values of pixel before and after the animation step. When ordered and displayed as part of the animation step, the offset images may decrease the perceived abruptness associated with the animation step (such as where a pixel may be going from empty to filled within a single step) by providing incremental changes in the pixel values. In this manner, the perceived abruptness of an animation sequence may be reduced and the apparent smoothness of the animation increased.

### BRIEF DESCRIPTION OF THE DRAWINGS

These and other features, aspects, and advantages of the present invention will become better understood when the following detailed description of certain exemplary embodiments is read with reference to the accompanying drawings in which like characters represent like parts throughout the drawings, wherein:

FIG. 1 is a view of an exemplary portable electronic device having a display, in accordance with aspects of the present technique;

FIG. 2 is a block diagram of exemplary components of the portable electronic device of FIG. 1, in accordance with aspects of the present technique;

FIG. 3 is a flowchart depicting certain exemplary logic for implementing certain aspects of an animation procedure, in accordance with aspects of the present technique;

FIG. 4A is an exemplary screenshot depicting an image to be animated on a display, in accordance with aspects of the present technique;

FIG. 4B is an exemplary representation depicting pixel intensity values for the screenshot of FIG. 4A, in accordance with aspects of the present technique;

FIG. 5A is an exemplary screenshot depicting an image being animated on a display, in accordance with aspects of the present technique;

FIG. 5B is an exemplary representation depicting pixel intensity values for the screenshot of FIG. 5A, in accordance with aspects of the present technique;

FIG. 6A is an exemplary screenshot depicting an image being animated on a display, in accordance with aspects of the present technique;

FIG. 6B is an exemplary representation depicting pixel intensity values for the screenshot of FIG. 6A, in accordance with aspects of the present technique;

FIG. 7A is an exemplary screenshot depicting an image which has been diagonally moved on a display, in accordance with aspects of the present technique; and

FIG. 7B is an exemplary representation depicting pixel intensity values for the screenshot of FIG. 7A, in accordance with aspects of the present technique.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

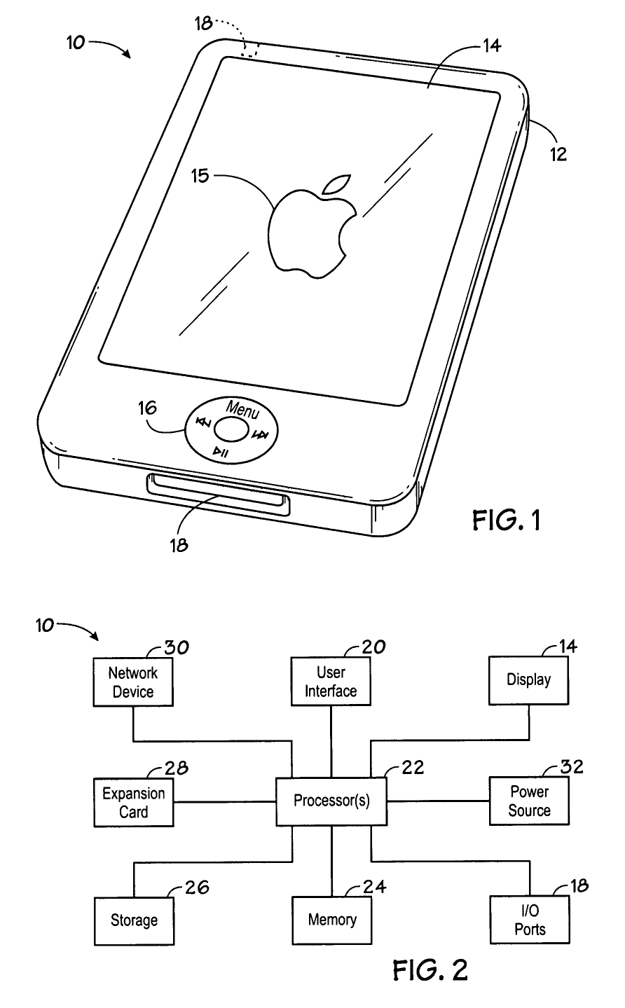

Turning now to the figures, FIG. 1 depicts an electronic device 10 in accordance with one embodiment of the present invention. In some embodiments, the electronic device 10 may be a media player for playing music and/or video, a cellular phone, a personal data organizer, or any combination thereof. Thus, the electronic device 10 may be a unified device providing any one of or a combination of the functionality of a media player, a cellular phone, a personal data organizer, and so forth. In addition, the electronic device 10 may allow a user to connect to and communicate through the Internet or through other networks, such as local or wide area networks. For example, the electronic device 10 may allow a user to communicate using e-mail, text messaging, instant messaging, or using other forms of electronic communication. By way of example, the electronic device 10 may be a model of an iPod® having a display screen or an iPhone® available from Apple Inc.

In certain embodiments the electronic device 10 may be powered by a rechargeable or replaceable battery. Such battery-powered implementations may be highly portable, allowing a user to carry the electronic device 10 while traveling, working, exercising, and so forth. In this manner, a user of the electronic device 10, depending on the functionalities provided by the electronic device 10, may listen to music, play games or video, record video or take pictures, place and take telephone calls, communicate with others, control other devices (e.g., the device 10 may include remote control and/or Bluetooth functionality, for example), and so forth while moving freely with the device 10. In addition, in certain embodiments the device 10 may be sized such that it fits relatively easily into a pocket or hand of the user. In such embodiments, the device 10 is relatively small and easily handled and utilized by its user and thus may be taken practically anywhere the user travels. While the present discussion and examples described herein generally reference an electronic device 10 which is portable, such as that depicted in FIG. 1, it should be understood that the techniques discussed herein may be applicable to any electronic device having a display, regardless of the portability of the device.

In the depicted embodiment, the electronic device 10 includes an enclosure 12, a display 14, user input structures 16, and input/output connectors 18. The enclosure 12 may be formed from plastic, metal, composite materials, or other suitable materials or any combination thereof. The enclosure 12 may protect the interior components of the electronic device 10 from physical damage, and may also shield the interior components from electromagnetic interference (EMI).

The display 14 may be a liquid crystal display (LCD) or may be a light emitting diode (LED) based display, an organic light emitting diode (OLED) based display, or other suitable display. In accordance with certain embodiments of the present technique, the display 14 may display a user interface as well as various images 15, such as logos, avatars, photos, album art, and so forth. Additionally, in one embodiment the display 14 may be a touch screen through which a user may interact with the user interface. The display 14 may also display various function and/or system indicators to provide feedback to a user, such as power status, call status, memory status, etc. These indicators may be in incorporated into the user interface displayed on the display 14.

In one embodiment, one or more of the user input structures 16 are configured to control the device 10, such as by controlling a mode of operation, an output level, an output type, etc. For instance, the user input structures 16 may include a button to turn the device 10 on or off. In general, embodiments of the electronic device 10 may include any number of user input structures 16, including buttons, switches, a control pad, keys, knobs, a scroll wheel, or any other suitable input structures. The input structures 16 may work with a user interface displayed on the device 10 to control functions of the device 10 or of other devices connected to or used by the device 10. For example, the user input structures 16 may allow a user to navigate a displayed user interface or to return such a displayed user interface to a default or home screen.

The electronic device 10 may also include various input and output ports 18 to allow connection of additional devices. For example, a port 18 may be a headphone jack that provides for connection of headphones. Additionally, a port 18 may have both input/output capabilities to provide for connection of a headset (e.g. a headphone and microphone combination). Embodiments of the present invention may include any number of input and/or output ports, including headphone and headset jacks, universal serial bus (USB) ports, Firewire or IEEE-1394 ports, and AC and/or DC power connectors. Further, the device 10 may use the input and output ports to connect to and send or receive data with any other device, such as other portable electronic devices, personal computers, printers, etc. For example, in one embodiment the electronic device 10 may connect to a personal computer via a Firewire or IEEE-1394 connection to send and receive data files, such as media files.

Turning now to FIG. 2, a block diagram of components of an illustrative electronic device 10 is shown. The block diagram includes the display 14 and I/O ports 18 discussed above. In addition, the block diagram illustrates the user interface 20, one or more processors 22, a memory 24, storage 26, card interface(s) 28, networking device 30, and power source 32.

As discussed herein, in certain embodiments the user interface 20 may be displayed on the display 14, and may provide a means for a user to interact with the electronic device 10. The user interface may be a textual user interface, a graphical user interface (GUI), or any combination thereof, and may include various layers, windows, screens, templates, elements or other components that may be displayed in all of or areas of the display 14.

The user interface 20 may, in certain embodiments, allow a user to interface with displayed interface elements via the one or more user input structures 16 and/or via a touch sensitive implementation of the display 14. In such embodiments, the user interface provides interactive functionality, allowing a user to select, by touch screen or other input structure, from among options displayed on the display 14. Thus the user can operate the device 10 by appropriate interaction with the user interface 20.

The processor(s) 22 may provide the processing capability required to execute the operating system, programs, user interface 20, and any other functions of the device 10. The processor(s) 22 may include one or more microprocessors, such as one or more “general-purpose” microprocessors, a combination of general and special purpose microprocessors, and/or ASICS. For example, the processor(s) 22 may include one or more reduced instruction set (RISC) processors, such as a RISC processor manufactured by Samsung, as well as graphics processors, video processors, and/or related chip sets.

Embodiments of the electronic device 10 may also include a memory 24. The memory 24 may include a volatile memory, such as RAM, and a non-volatile memory, such as ROM. The memory 24 may store a variety of information and may be used for a variety of purposes. For example, the memory 24 may store the firmware for the device 10, such as an operating system for the device 10 and/or any other programs or executable code necessary for the device 10 to function. In addition, the memory 24 may be used for buffering or caching during operation of the device 10.

The device 10 in FIG. 2 may also include non-volatile storage 26, such as ROM, flash memory, a hard drive, any other suitable optical, magnetic, or solid-state storage medium, or a combination thereof. The storage 26 may store data files such as media (e.g., music and video files), software (e.g., for implementing functions on device 10), preference information (e.g., media playback preferences), lifestyle information (e.g., food preferences), exercise information (e.g., information obtained by exercise monitoring equipment), transaction information (e.g., information such as credit card information), wireless connection information (e.g., information that may enable media device to establish a wireless connection such as a telephone connection), subscription information (e.g., information that maintains a record of podcasts or television shows or other media a user subscribes to), telephone information (e.g., telephone numbers), and any other suitable data.

The embodiment in FIG. 2 also includes one or more card slots 28. The card slots 28 may receive expansion cards that may be used to add functionality to the device 10, such as additional memory, I/O functionality, or networking capability. The expansion card may connect to the device 10 through any type of connector and may be accessed internally or externally to the enclosure 12. For example, in one embodiment the card may be a flash memory card, such as a SecureDigital (SD) card, mini- or microSD, CompactFlash card, Multimedia card (MMC), etc. Additionally, in some embodiments a card slot 28 may receive a Subscriber Identity Module (SIM) card, for use with an embodiment of the electronic device 10 that provides mobile phone capability.

The device 10 depicted in FIG. 2 also includes a network device 30, such as a network controller or a network interface card (NIC). In one embodiment, the network device 30 may be a wireless NIC providing wireless connectivity over any 802.11 standard or any other suitable wireless networking standard. The network device 30 may allow the device 10 to communicate over a network, such as a LAN, WAN, MAN, or the Internet. Further, the device 10 may connect to and send or receive data with any device on the network, such as other portable electronic devices, personal computers, printers, etc. For example, in one embodiment, the electronic device 10 may connect to a personal computer via the network device 30 to send and receive data files, such as media files. Alternatively, in some embodiments the electronic device may not include a network device 30. In such an embodiment, a NIC may be added into card slot 28 to provide similar networking capability as described above.

The device 10 may also include or be connected to a power source 32. In one embodiment, the power source 32 may be a battery, such as a Li-Ion battery. In such embodiments, the battery may be rechargeable, removable, and/or attached to other components of the device 10. Additionally, in certain embodiments the power source 32 may be an external power source, such as a connection to AC power and the device 10 may be connected to the power source 32 via the I/O ports 18.

As will be appreciated, the electronic device 10 described above may take a variety of forms and may perform a variety of functions. In performing those functions, the display 14 of the device 10 may be used to display various images 15. For example, the display 14 may be used to display images at the request of the user or for aesthetic appeal when a function is being performed that is not otherwise utilizing the display 14, such as the playing of audio files. Further, the various aspects and screens of the user interface may also be considered to be images that are displayed when appropriate based on the state of the device 10.

In some instances, it may be desirable to animate the images 15 being displayed on the device 10. For example, it may be desirable to animate an otherwise static image 15 such that the image 15, or parts of the image 15, are moved or rotated on the display 14, either two-dimensionally or three-dimensionally. Likewise, to the extent that the user interface may display images, such as screens of the interface, it may be desirable to animate transitions between screens of the user interface, thereby creating the illusion of physical movement and transition.

Such animation may involve a sequence of incremental steps whereby the image being animated is “moved” pixel-by-pixel on the display 14. This effect is achieved by sequentially redrawing the image 15 being animated at different locations on the display 14 in the direction of movement. Typically, the image 15 is displaced and redrawn in small increments or steps so that the animation appears as smooth as possible. For example, in an animation sequence where the image 15 is animated in a rightward direction on the display 14, the image 15 may be displaced and redrawn one-pixel to the right for as many iterations as it takes the image 15 to reach the point at which animation is to cease, such as the right edge of the display 14. In each step of the overall animation sequence, the image 15 is redrawn such that the pixels forming the image 15 at the end of the animation step have the same values (intensity, color, and so forth) as the corresponding pixels at the beginning of the animation step. However, on a small display 14, such an animation sequence may not be aesthetically pleasing due to the resolution of the display 14. In particular, if the pixels are too large, the discrete animation steps may be noticeable to a viewer, thus detracting from the illusion of smooth movement of the image 15.

The present technique provides for the display of one or more offset images within the animation steps of an animation sequence. To simplify the present discussion, pixel values will generally be discussed as being between 1 and 0, e.g., a gray-scale implementation where the value between 1 and 0 represents the percentage of black displayed in a pixel, with 1 corresponding to totally black and 0 corresponding to totally white. It should be appreciated, however, that the present technique is equally applicable to color implementations and/or to other pixel value representation schemes.

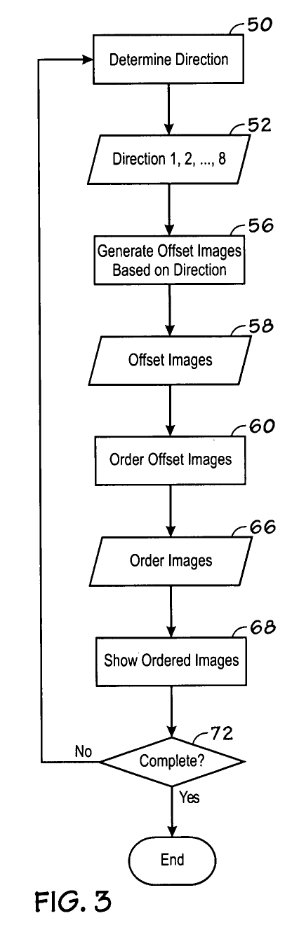

Returning to the figures and referring now to FIG. 3, a flowchart is depicted that sets forth exemplary logic for animating an image on a display 14 of the electronic device 10 of FIGS. 1 and 2. As depicted by the exemplary logic, a direction 52 is determined (block 50) in which some or all of the pixels of the image 15 are to be moved in an animation process. For the purpose of the present discussion, the number of possible directions 52 will be limited to eight, generally corresponding to the cardinal directions and intermediate diagonals.

Determining the direction for the animation at Block 50 may be performed automatically or by a user. For example, in certain embodiments, the direction 52 may be randomly determined, such as by execution of random number generation code on a processor 22. Such implementations may be employed where variability or randomness is desired and user input is not feasible or not desired. Likewise, set animations may be employed in certain embodiments where the animation always proceeds in a certain direction 52 by design, such as for a screen transition or animation that is always implemented in the same manner to provide a consistent interface. Alternatively, the direction 52 may be determined at block 50 in response to a user action or user input, such as based upon a user menu or program selection or based upon a scrolling function performed in response to a user action.

It should be understood that, for complex animations, different portions of the image may move in different directions 52. For example, an animation of a figure walking may be implemented by providing animation for the head and torso of the figure that differs from the animation provided for the arms and legs of the figure. In particular, the pixels defining different portions of an image may move in different directions 52. Thus, for such a complex animation, determining a direction 52 at block 50 may be implemented on pixel-by-pixel basis or may be implemented separately for different subsets of pixels defining different regions of the image that are being differentially animated. For simplicity, the present discussion and examples will be based on an image in which the pixels comprising the image all move in the same direction. It should be understood, however, that the present technique is equally applicable to more complex animations where different pixels of an image are moved in different directions 52.

In an exemplary embodiment, based on the direction 52 that the animation sequence is to proceed, one or more offset images 58 are generated (block 56). Each offset image 58 provides an incremental change in the respective pixel display values for the pixels undergoing animation. For example, in one embodiment, each pixel of an offset image 58 will have a value that is between the pixel's value prior to the animation step and the pixel's value subsequent to the animation step, provided there is a change in the pixels value in the animation step. Thus, if pixel (1,1) has a value of 1 at the beginning of the animation step and a value of 0 after the animation step is performed, the one or more offset images 58 generated for this step of the animation will have values greater than 0 and less than 1 at pixel (1,1).

In accordance with the depicted exemplary logic, if more than one offset image 58 has been generated for a given animation step, the respective offset images 58 for the animation step are ordered (block 62). The ordering of the offset images 58 is based on the direction 52 of the animation. In particular, the offset images 58 are ordered such that the incremental pixel value changes reflected in the offset images 58 are consistent with the pixel values at the beginning and end of the animation step. For example, if a ¼ offset image and a ¾ offset image are present for a given animation step (i.e., a ¼ offset image would have pixel values that are incremented by ¼ of the difference between the pre- and post-animation step values for a given pixel while the ¾ offset image would have pixel values that are incremented by ¾ of the difference between the pre- and post-animation step values for the given pixel), the offset images 58 would be ordered so that when displayed, the change in the pixel values is in the appropriate direction.

For example, if, based on the direction of animation 52, a given pixel is going from a value of 0.25 at the beginning of an animation step to a value of 0.66 at the end of the animation step, a ¼ offset image 58 would have a value of 0.3525 at the given pixel while the ¾ offset image would have a value of 0.5575 at the given pixel. The offset images 58 in this example would, therefore, be ordered such that the ¼ image precedes the ¾ image so that, when displayed, the value of the given pixel goes from 0.25 to 0.3525 to 0.5575 to 0.66. Conversely, if the direction 52 of animation was such that the given pixel value was going from 0.66 to 0.25, the offset images 58 would be ordered such that the ¾ image precedes the ¼ image so that, when displayed, the value of the given pixel goes from 0.66 to 0.5575 to 0.3525 to 0.25.

As the animation sequence proceeds, each animation step is sequentially displayed (block 68) such that the respective beginning of the animation step is displayed, followed by the ordered offset images 66, followed by the end of the animation step (which in turn is the beginning of the next animation step). The one or more animation steps are processed for a given animation sequence in a given direction 52. Once an animation sequence in a given direction is played, a determination is made whether animation of the object is complete (Block 72). If the animation is complete, no further action is taken until a new animation sequence begins. If, however, the animation is not determined to be complete, the process may be repeated in a determined direction.

While the preceding discussion suggests that the various offset images 58 are generated and/or ordered as part of a single operation, this is for the purpose of illustration only. In implementation, the present technique may be implemented on the fly or in an iterative manner. For example, the offset images 58 may be generated for an animation step, ordered, and displayed as part of the animation step before or concurrent with the generation and ordering of the next set of offset images associated with the subsequent animation step of the animation sequence.

While the preceding discussion generally illustrates the generation and use of offset images 58 in animation, the following examples are also provided to further illustrate the preset techniques. In the first example, a single offset image 58 is provided for a given animation step. In this example, the pixel values in each offset image 58 are the average of the respective pixel values before and after the animation step, as determined by the direction in which the animation proceeds. In other words, in such an example, the offset image 58 may be considered to be an average image formed from the pre- and post-animation step images such that:

Value_{(x,y)}=(Value_{(x,y)}+Value′_{(x,y)})/2 (1)

where Value_{(x,y)} is the value of a respective pixel prior to animation and Value′_{(x′,y′)} is the value of the respective pixel subsequent to animation. Alternatively, Value_{(x,y)} may be considered to be the value of a respective pixel and Value′_{(x′,y′)} may be considered to be the value of the pixel “moving” into the respective pixel as a consequence of the animation, as determined from the animation direction 52. Such an offset image may be considered a ½ step offset image since the pixel values of the offset image are incremented by ½ of the difference between the pre- and post-animation step values for a given pixel.

For instance, assume that animation is proceeding to the right and, prior to animation, pixel (1,1) has a value of 0.66, pixel (2,1) has a value of 1.0 and pixel (3,1) has a value of 0.25. Thus, at the end of a single animation step, assuming animation proceeds in one-pixel increments, pixel (2,1) has a value of 0.66, pixel (3,1) has a value of 1.0, and pixel (4,1) has a value of 0.25, and so forth. The ½ step offset image, therefore, has pixel values such that pixel (2,1) has a value of 0.83, pixel (3,1) has a value of 0.625, and pixel (4,1) has a value of 0.125. The ½ step offset image will be displayed between the beginning and the end of the animation step such that these respective pixels have the following values during the animation step:

Pixel

| | 1, 1 | 2, 1 | 3, 1 | 4, 1 |
|---|---|---|---|---|
| Beginning | 0.66 | 1.0 | 0.25 | |
| Intensity | | | | |
| ½ Offset | | 0.83 | 0.625 | 0.125 |
| Intensity | | | | |
| End | | 0.66 | 1.0 | 0.25 |
| Intensity | | | | |

Therefore, for this example, each animation step includes a transitional image in the form of the ½ offset image which creates the impression of a smoother transition in the animation step.

In another example, quarter step offset images may be generated for each animation step such as offset images representing ¼ and ¾ steps between the pre-animation step and post-animation step images. In such an example, the ¼ offset image may be formed from the pre- and post-animation step images such that:

Value_{(x,y)}=(Value_{(x,y)}+((Value_{(x,y)}+Value′_{(x,y)})/2)/2 (2)

while the ¾ offset image may be formed from the pre- and post-animation step images such that:

Value_{(x,y)}=(Value′_{(x,y)}+((Value_{(x,y)}+Value′_{(x,y)})/2)/2 (3)

where Value_{(x,y)} is the value of a respective pixel prior to animation and Value′_{(x′,y′)} is the value of the respective pixel subsequent to animation. Alternatively, as noted above, Value_{(x,y)} may be considered to be the value of a respective pixel and Value′_{(x′,y′)} may be considered to be the value of the pixel “moving” into the respective pixel as a consequence of the animation, as determined from the animation direction 52.

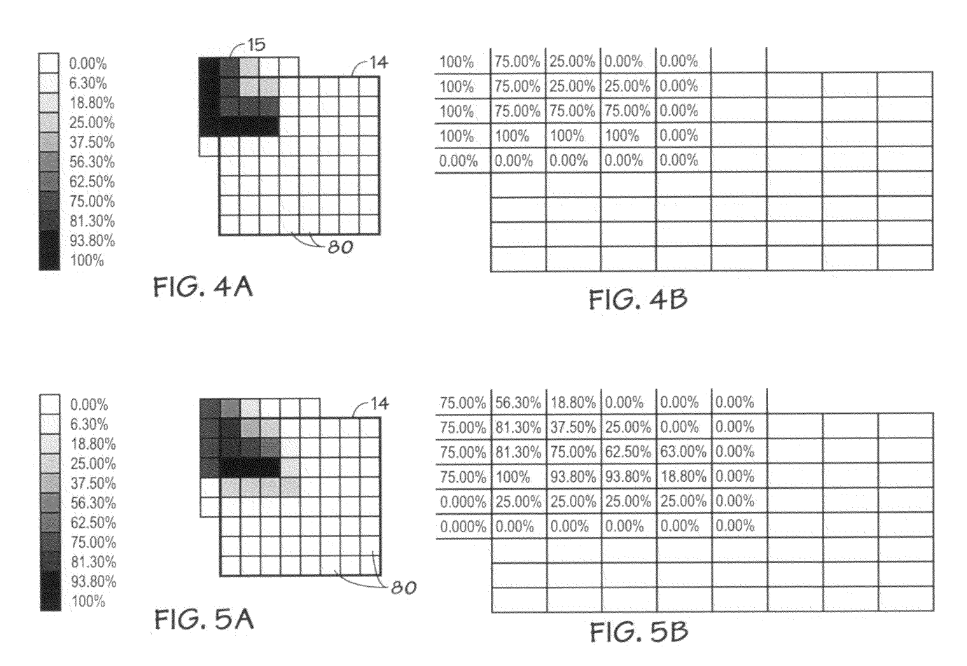

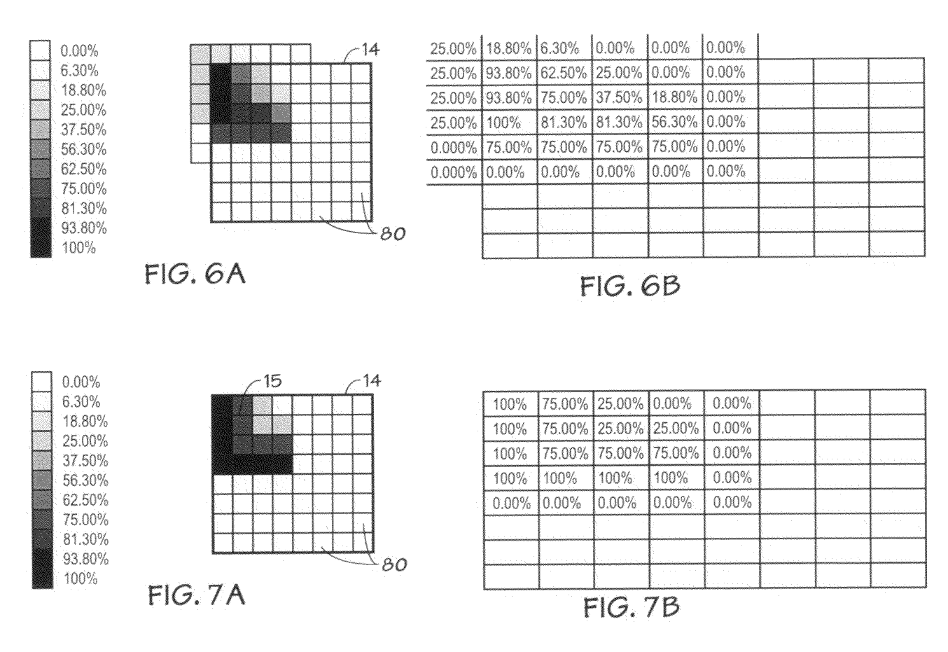

For instance, referring now to FIGS. 4A through 7B, an exemplary image 15 is depicted as moving diagonally onto the display 14 from off-screen in a downward and right direction. The pixels 80 forming the image 15 have different intensities, as depicted graphically in FIG. 4a and numerically in FIG. 4B. as depicted, FIGS. 4A and 4B illustrate the position of the image 15 at the beginning of an animation step. The ¼ offset image, as depicted graphically and numerically in FIGS. 5A and 5B respectively, illustrates a transition from the beginning of the animation step where each pixel 80 has a value that has been incremented by ¼ of the difference between the initial and final pixel values for the animation step, in accordance with equation (2). Likewise, the ¾ offset image, as depicted graphically and numerically in FIGS. 6A and 6B respectively, illustrates the continuing transition where each pixel 80 has a value that has been incremented by ¾ of the difference between the initial and final pixel values for the animation step, in accordance with equation (3). At the end of the animation step, as depicted graphically and numerically in FIGS. 7A and 7B, the image 15 has been moved one pixel right and down, but without abrupt changes in pixel intensities that might be perceived as abrupt or otherwise unappealing. If the animation were to continue, the image 15 as depicted in FIGS. 7A and 7B may serve as the beginning of the next step of the animation.

While the preceding examples of the use of offset images 58 in increments of ½ step, and of ¼ and ¾ steps have been provided to illustrate the present technique steps and combinations of steps are also possible. For example, based on the examples above, an animation step in which ¼, ½, and ¾ step offset images are displayed as part of an animation step is readily apparent. However, other fractional offset steps and other combinations of such steps may also be implemented in view of the preceding disclosure. In one embodiment of the present technique, the number of increments or offsets provided between the beginning and end points of the animation step may be greater when the resolution of the display is lower, i.e., the number of offset images may be inversely proportional to the display resolution. For example, for a low resolution display it may be useful to provide offset images for eighths of the image (i.e., ⅛, ¼, ⅜, ½, and so forth) or sixteenths of the image (i.e., 1/16, ⅛, 3/16, ¼, and so forth). In this manner, the number of offset images utilized can be selected and/or customized based on the resolution of the display in question. It should be understood that the present techniques are in no way limited by the present examples, which have been provided for the purpose of illustration only and not as limiting embodiments.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method for animating an image, comprising:
generating one or more offset images for an image undergoing animation; and
displaying the one or more offset images as part of a step of the animation.

2. The method of claim 1, comprising ordering the offset images prior to displaying the one or more offset images.

3. The method of claim 1, comprising determining a direction in which the image undergoes animation.

4. The method of claim 1, comprising iterating generating and displaying the one or more offset images until the animation of the image is concluded.

5. The method of claim 1, wherein generating the one or more offset images comprises calculating a value for each pixel forming the image based upon the value of the corresponding pixel before and after an animation step.

6. The method of claim 5, wherein the value is between the value of the corresponding pixel at the beginning of the animation step and the value of the pixel at the end of the animation step if the value of the corresponding pixel changes.

7. One or more tangible media, comprising executable code configured to:
determine one or more pixel values of an image undergoing animation;
generate one or more transitional images based on the one or more pixel values; and
display the one or more transitional images as part of one or more animation steps by which the image is animated.

8. The one or more tangible media of claim 7, comprising code executable to determine a direction in which the image is animated.

9. The one or more tangible media of claim 7, wherein the executable code configured to generate the one or more transitional images generates an average or a weighted average pixel value for one or more pixels based upon an initial pixel value and a final pixel value for the respective pixels.

10. The one or more tangible media of claim 7, wherein the executable code configured to display the one or more transitional images orders the transitional images prior to displaying the transitional images.

11. The one or more tangible media of claim 7, comprising code executable to iterate the code configured to determine, generate, and display until an animation sequence is ended.

12. An electronic device, comprising:
a display;
one or more processors; and
a storage device;
wherein the one or more processors are configured to execute routines stored in the storage device for animating images on the display, wherein the routines are configured to display one or more offset images as part of each animation step and wherein each offset image includes pixel values that are between the pixel values for the respective pixels before and after a respective animation step if the respective pixel value changes.

13. The electronic device of claim 12, wherein the electronic device comprises one of a media player, a cellular phone, or a personal data organizer.

14. The electronic device of claim 12, wherein the electronic device comprises a portable electronic device.

15. The electronic device of claim 12, wherein the one or more processors are configured to generate the one or more offset images prior to displaying the one or more offset images.

16. An electronic device configured to display an animation, the electronic device comprising:
one or more processing components configured to execute code for: displaying an image on a display of the electronic device, determining one or more animation steps to animate the image on the display, and displaying the animation steps in conjunction with one or more intermediary images such that the abruptness of each animation step is decreased for pixels that are changed in the animation step.

17. The electronic device of claim 16, wherein the one or more processing components are configured to generate the one or more intermediary images based on the beginning and ending pixel values for the respective animation step.

18. The electronic device of claim 17, wherein the intermediary images are generated as a fraction of the difference of the beginning and ending pixel values for the respective animation step.

19. An animation, comprising:
a series of animation steps, wherein some or all of the animation steps, when viewed sequentially create a perception of motion; and
one or more transitional images associated with some or all of the animation steps, the one or more transitional images comprising pixel values intermediate to the corresponding pixel values in the beginning and end of the respective animation step when the corresponding pixel values change in the animation step.

20. The animation of claim 19, wherein the one or more transitional images comprises pixel values that are an average or weighted average of the corresponding pixel values in the beginning and end of the respective animation step.
